(19) United States
(12) Patent Application Publication
(10) Pub. No.: US 2015/0362055 A1
(43) Pub. Date: Dec. 17, 2015

(54) BEVEL GEAR WHEEL DIFFERENTIAL FOR A MOTOR VEHICLE

(71) Applicant: Schaeffler Technologies GmbH & Co. KG, Herzogenaurach (DE)

(72) Inventors: Thorsten Biermann, Wachenroth (DE); Florian Wilm, Nuedlingen (DE)

(21) Appl. No.: 14/418,748

(22) PCT Filed: Jun. 4, 2013
(86) PCT No.: PCT/EP2013/061470

§ 371 Date: Aug. 20, 2015

(30) Foreign Application Priority Data
Jul. 31, 2012 (DE) 10 2012 213 405.3

(51) Int. Cl. F16H 48/40; F16H 48/08

(52) U.S. Cl. CPC F16H 48/40; F16H 48/08

(57) ABSTRACT

A bevel gear differential including an external gear, a differential cage rigidly connected to the external gear by means of at least one connecting region, at least one web region of the differential cage on which a compensating gear is disposed, an axis of rotation of the compensating gear, an axial compensation direction defined by the axis of rotation of the compensating gear, and at least one angular compensation region of at least +/−20 degrees about the axial compensation direction and arranged in a plane perpendicular to the axial compensation direction, wherein the at least one angular compensation region is freed from the at least one connecting region.

### CROSS-REFERENCE TO RELATED APPLICATIONS

The present application is the U.S. national stage application pursuant to 35 U.S.C. §371 of International Application No. PCT/EP2013/061470, filed on Jun. 4, 2013, which application claims priority from German Patent Application No. DE 102012213405.0, filed on Jul. 31, 2012, which applications are incorporated herein by reference in their entireties.

### TECHNICAL FIELD

The invention relates to a bevel gear differential including an external gear, having a differential cage, where the differential cage is rigidly connected to the external gear by means of at least one connecting region, where the differential cage has at least one web region, on which a compensating gear is disposed, where the axis of rotation of the compensating gear defines an axial compensation direction in an axial plan view of the bevel gear differential.

### BACKGROUND

Bevel gear differentials are often used in vehicles, in order to distribute a drive torque between two output shafts. The bevel gear differential allows by means of compensating gear wheels that the two output shafts can be rotated against each other, in order to be able to compensate in this way, for example, the varying angular velocities when vehicles are driving through a curve.

EP 1472475 B1 shows such a bevel gear differential. As disclosed in EP 1472475 B1, the bevel gear differential comprises a differential case, which can be driven by a ring gear, which is rigidly connected to this case, and compensating gears, which are rotatably mounted in the differential case, and, in addition two planet gears, which are also rotatably mounted in the differential case, and with which the compensating gears mesh and in this way form the outputs of the bevel gear differential.

The object of the present invention is to further develop a bevel gear differential of the design known from the prior art. Example or advantageous embodiments of the invention will become apparent from the dependent claims, the following description and the accompanying figures.

### SUMMARY

According to aspects illustrated herein, there is provided a bevel gear differential including an external gear, a differential cage rigidly connected to the external gear by means of at least one connecting region, at least one web region of the differential cage on which a compensating gear is disposed, an axis of rotation of the compensating gear, an axial compensation direction defined by the axis of rotation of the compensating gear, and at least one angular compensation region of at least +/−20 degrees about the axial compensation direction and arranged in a plane perpendicular to the axial compensation direction, wherein the at least one angular compensation region is freed from the at least one connecting region.

The invention proposes a bevel gear differential that is suitable and/or designed for use in a vehicle. The bevel gear differential can be designed, on the one hand, as a longitudinal differential, with which a drive torque can be distributed between two axles of the vehicle. In an example embodiment, the bevel gear differential is designed as a transverse differential or an axial differential, where in this case, a drive torque is distributed between two output shafts of an axle. In alternative embodiments the bevel gear differential may also be used to merge or distribute the drive torques.

The bevel gear differential comprises an external gear, which is designed, for example, as a gear wheel, which is circumferentially toothed on an end face, or as a gear ring. The teeth of the gear tooth system of the external gear extend, in an example embodiment, parallel to a main axis of rotation, which is defined by the external gear. In an example embodiment, the external gear forms an input or a drive gear of the bevel gear differential.

Furthermore, the bevel gear differential comprises a differential cage, which is also called a differential ease, where in this case, the differential cage is rigidly connected to the external gear by means of at least one connecting region. The shape of the differential cage is designed, for example, in the form of a bell or dome. The differential cage forms an internal space, so that the compensating gears and the output gears, which together form a compensating mechanism, are disposed in the internal space.

In particular, the bevel gear differential has two such output gears, which are coupled and/or can be coupled to the output shafts in such a way that they are rotationally rigid. The bevel gear differential comprises, in an example embodiment, at least one such compensating gear, where in this case, the compensating gear meshes with the two output gears. The compensating gear or gears and the output gears are designed, in an example embodiment, as bevel gears. In particular, the basic shape of the bevel gears is a truncated cone with an outer shell that is toothed.

The differential cage comprises at least one web region, on which the compensating gear is arranged. In an example embodiment, the web region bears a pin, on which the compensating gear is mounted in a manner allowing rotation.

For the purpose of the definition, it is established that in an axial plan view of the bevel gear differential, in the direction of the main axis of rotation of the external gear, the axis of rotation of the compensating gear defines an axial compensation direction. When defining structures in relation to the axial plan view, the axial plan view can also be defined as a plane perpendicular to the axial compensation direction.

It is proposed within the scope of the invention that in the same axial plan view, an angular compensation region of at least +/−20 degrees about the axial compensation direction be freed from the at least one connecting region. Therefore, in the case of the bevel gear differential as recited in the invention, it is claimed that the connecting regions are not arranged in an angular segment of the web region, but rather are located outside this angular segment.

The invention is based on the idea that the axial loads and also the tilting moment loads are removed from the differential cage in the direction of the external gear by way of the web regions. However, the differential cage in the web region is structurally designed to be very stiff, so that a support in the angular segment of the web region on the external gear is not absolutely mandatory. In contrast, the differential cages are often provided with recesses in the regions that are complementary to the web regions, and in this case, the differential cages in these regions have a lower flexural stiffness. The present invention is based on these preliminary considerations, and it is proposed that the connecting regions of the web regions, which are very stiff in any event, be moved in the circumferential direction about the main axis of rotation and that the connecting regions be arranged in such a way that they are set apart from the web regions.

As such, it has turned out that an angular compensation region of at least +/−20 degrees, or in an example embodiment, at least +/−30 degrees, can be freed from the connecting regions without adversely affecting the stiffness of the “external gear differential cage” assembly. It is even more advantageous that the angular compensation region be less than +/−90 degrees, in order not to reduce too much the connecting cross section in the circumferential direction.

As a result, the invention eliminates the need for connecting regions by dispensing with the “anxiety connections” in the web regions. Therefore, the invention lowers the manufacturing costs of the bevel gear differential by reducing the number of working steps and connecting components.

In an example embodiment of the invention, the differential cage comprises at least one window region. Such a window region is situated in the circumferential direction adjacent to the at least one web region and allows a weight reduction of the differential cage. In an axial plan view, the window region can be assigned a center line that divides the window region, for example, with respect to the extension in the circumferential direction and/or with respect to the opening area, into two symmetrical parts. This center line is defined as a window direction. About the window direction, an angular window region of at least +/−20 degrees can be defined, where in this case, the connecting regions are arranged in the at least one angular window region. If a plurality of window regions are provided in the differential cage, then a plurality of angular window regions are defined, so that the connecting regions are distributed among the angular window regions. As an alternative, the center line can be defined as a line perpendicular to the direction of compensation.

In particular, the angular compensation regions and the angular window regions are arranged in the circumferential direction so as to be adjacent to each other and are either spaced apart or are arranged immediately adjacent to one another, and/or are arranged so as not to overlap each other.

This example embodiment highlights that the connecting regions are to be moved in the circumferential direction out of the angular compensation regions into the angular window regions. This strategy utilizes the fact that the stiffness of the “external gear differential cage” assembly with respect to the displacement in the axial direction is greater in the direction of the web region than in the direction of the window region. In designing the structure, however, only the more compliant side, i.e., the window region, is the decisive factor, so that the connecting regions are placed in the more compliant region.

In an example further development of the invention, the differential cage has a circumferential ring section that is closed about the main axis of rotation of the external gear. This ring section ensures that the web regions can dissipate the axial loads and tilting loads by way of the connecting regions that are offset in the circumferential direction.

In an example further development of the invention, the ring section comprises at least one flange region, which extends in a radial plane perpendicular to the main axis of rotation of the external gear, and at least one mounting element, where in this case the at least one flange region is disposed, when viewed in the circumferential direction, in the at least one angular window region and/or is positioned outside the angular compensation region. The at least one flange region rests on the external gear and is connected to the external gear by means of the at least one mounting element. The at least one connecting region is formed by means of the connection.

It is advantageous for the external gear to have at least one recessed region, where in this case the recessed region is overlapped with the at least one angular compensation region and is arranged on the same pitch circle or diameter as the connecting regions. This measure achieves the objective that, on the one hand, the amount of material required can be reduced, and, on the other hand, the weight can be reduced. This further development is based on the idea that regions in the external gear in the angular segment of the web regions are no longer necessary due to the fact that the connecting regions are moved into the angular window regions or rather are moved out of the angular compensation regions and, as a result, can be dispensed with, The net result of this measure is a (further) reduction in weight and, thus, a reduction in inertia.

It is also advantageous for the recessed region to extend in the circumferential direction over the entire angular compensation region. Hence, the recessed region extends at least over +/−20 degrees about the axial compensation direction. Furthermore, it is advantageous that the recessed region in the radial direction relative to the main axis of rotation extends further than the at least one connecting region and/or extends further than the at least one flange region. In this way, a large surface area of the external gear can remain free,

In an example design configuration of the invention, the differential cage comprises two web regions and two window regions in such a way that both regions are arranged so as to alternate with each other in the circumferential direction. Each web region is associated with a compensating gear. In particular, each web region has a pin for the purpose of a rotatable bearing arrangement of the compensating gear. In this embodiment, two angular compensation regions are defined, and each of the angular compensation regions extends by at least +/−20 degrees about the associated axial compensation direction, and/or two angular window regions are defined, and each of the angular window regions extends by +/−20 degrees about the window direction. In this embodiment, the bevel gear differential is formed as a lightweight module that, therefore, exhibits reduced inertia.

in an example further development of the invention, the external gear has a central recess, in particular, a recess that is circularly round in sections and into which the differential cage is inserted, as well as two side recesses, which are arranged so as to overlap with the angular window region, and connect to the central recess and form with this central recess a common recessed region and/or the recessed region.

in an example embodiment of the invention, the external gear has a circumferential toothed ring or toothed carrier as well as a planar inner region, where in this case at least 60% of the area of the planar inner region is formed as the recessed region.

Additional features, advantages and effects of the invention will become apparent from the following description of an example embodiment of the invention and the accompanying figures.

### BRIEF DESCRIPTION OF THE DRAWINGS

The present invention will be explained in greater detail below on the basis of preferred exemplary embodiments in connection with the associated figures.

The figures show the following:

FIG. 1 is a three dimensional schematic view of a bevel gear differential;

FIG. 2 is a side schematic view of the bevel gear differential from FIG. 1; and,

FIG. 3 is an axial plan view showing the rear of the bevel gear differential from FIGS. 1 and 2.

### DETAILED DESCRIPTION

At the outset, it should he appreciated that like drawing numbers on different drawing views identify identical, or functionally similar, structural elements of the invention. It is to be understood that the disclosure as claimed is not limited to the disclosed aspects.

Furthermore, it is understood that the claims are not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this invention belongs. It should be understood that any methods, devices or materials similar or equivalent to those described herein can be used in the practice or testing of the invention.

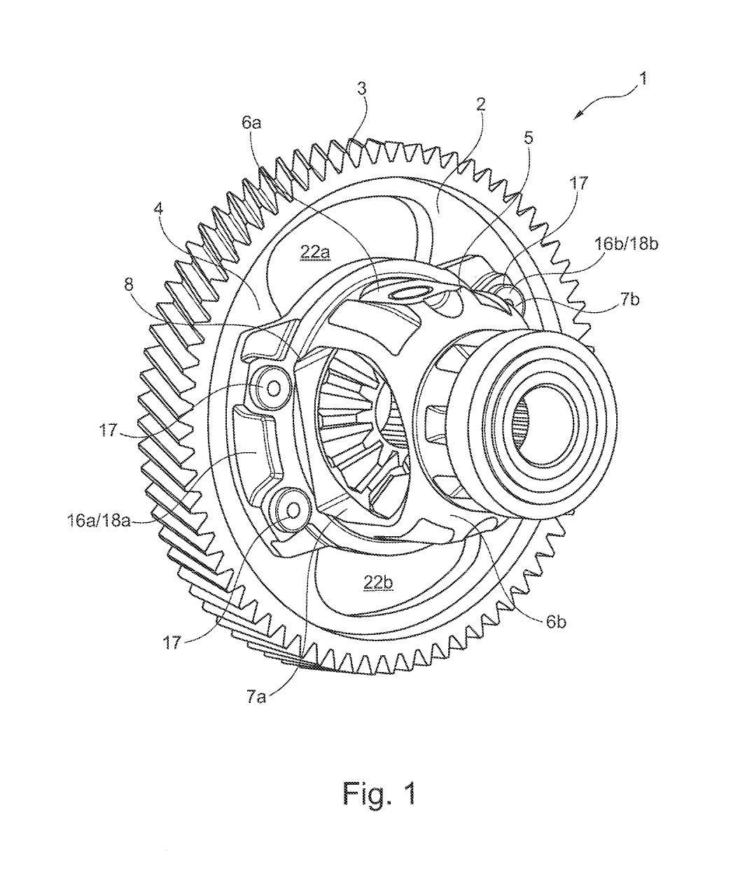

FIG. 1 is a schematic, three dimensional view of a bevel gear differential 1 that is designed for a vehicle. In particular, bevel gear differential 1 is used to distribute a drive torque between two output shafts (not shown).

Bevel gear differential 1 has an external gear 2 that is designed as a gear wheel, which is circumferentially toothed on the end face, or more specifically is designed as a crown gear. External gear 2 comprises a toothed external ring 3 and an internal region 4 configured in the shape of a plate. The plate shape of internal region 4 is formed as a planar or flat region.

A differential cage 5 is mounted on external gear 2, where in this case, differential cage 5 is constructed as a bell-shaped or dome-shaped casting. Differential cage 5 comprises two web regions 6a and 6b and two window regions 7a and 7b. Web regions 6a and 6b are formed by means of the case regions of differential cage 5. Web regions 6a and 6b alternate with window regions 7a and 7b in the circumferential direction.

Differential cage 5 comprises a circumferential ring section 8, where in this case, ring section 8 also connects web regions 6a and 6b in the circumferential direction by way of window regions 7a and 7b. Thus, window regions 7a and 7b are defined or formed by adjacent web regions 6a and 6b in the circumferential direction and by ring section 8 in the axial direction and by a roof region of differential cage 5.

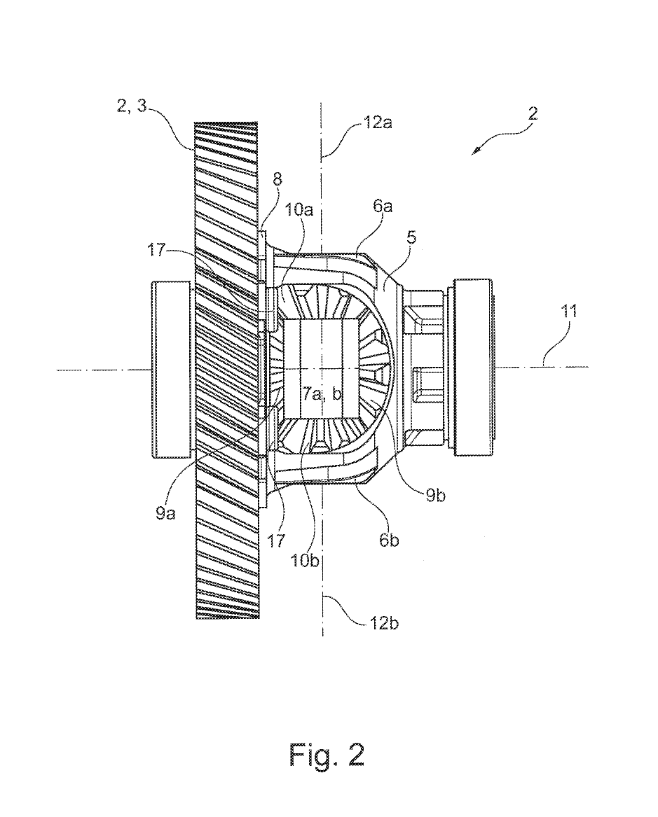

As can be seen, in particular, in FIG. 2, two output gears 9a and 9b and two compensating gears 10a and 10b are arranged in an internal space of differential cage 5. Output gears 9a and 9b are coaxial to a main axis of rotation 11 of external gear 2 and are connected in each instance to one of the output shafts, which are not shown. Output gears 9a and 9b are arranged in differential cage 5 in a manner allowing rotation. Each of compensating gears 10a and 10b meshes with both output gears 9a and 9b, so that a compensating mechanism or differential mechanism is provided. Compensating gears 10a and 10b are rotatably mounted in differential cage 5 by means of pins (not shown), which are secured in web regions 6a and 6b. The rotations of compensating gears 10a and 10b define axes of rotation 12a and 12b, which are oriented perpendicular to main axis of rotation 11 and are located on a common line.

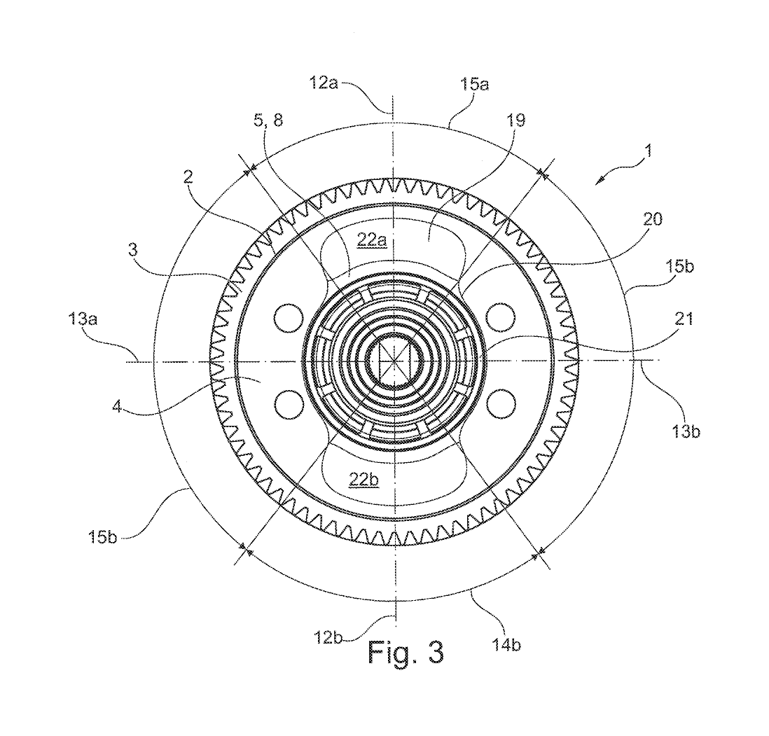

It can be seen from FIG. 3, which shows bevel gear differential 1 with respect to main axis of rotation 11 in an axial plan view of the rear side, that axes of rotation 12a and 12b define the directions of compensation. The compensation directions are located on a common line, which is arranged so as to be perpendicular to main axis of rotation 11. Window regions 7a and 7b can be divided in the middle, so that in the axial plan view a center line of the window regions 13a and 13b, which defines a window direction, can be assigned to each of the window regions. As an alternative to the definition of the window directions, perpendicular line to the axes of rotation 12a and 12b can also be defined as the center line, and, in so doing, as the window directions.

As shown in FIG. 3, external gear 2 can be divided into two angular compensation regions 14a and 14b as well as into two angular window regions 15a and 15b in the circumferential direction. Angular window regions 15a and 15b extend in an angular range of +/−40 degrees about axial direction of compensation, defined by center line of the window regions 13a and 13b. In contrast, angular window regions 15a and 15b extend in an angular range of +/−50 degrees about center line of the window regions 13a - 13b, so that angular compensation regions 14a and 14b and angular window regions 15a and 15b are complementary with respect to 360 degrees.

As can be seen again from FIG. 1, differential cage 5 has flange regions 16a and 16b, which are connected to external gear 2 by means of mounting elements 17, in this example, rivets, and form in this way connecting regions 18a and 18b.

Differential cage 5 is constructed much stiffer in the web regions 6a and 6b than in the window regions 7a and 7b. Due to this regional stiffness, the connection of differential cage 5 to external gear 2 is adapted with respect to the (flexural) stiffness in relation to the axial displacement of external gear 2 by tilting. This measure takes into account that in the design phase only or essentially the more compliant side, namely, the window side, is the key factor. Accordingly, the amount of material required can be reduced at the expense of reducing the stiffness of bevel gear differential 1 in the direction of the web by removing the material at differential cage 5 and by removing the material at external gear 2. Furthermore, the number of connecting elements (screws, rivets, etc.) required in the area of the removed material can be reduced.

When bevel gear differential 1 as depicted in FIG. 1 is compared with bevel gear differential 1 as depicted in FIG. 3, it can be seen that mounting elements 17 and, associated with them, connecting regions 18a and 18b are arranged in the circumferential direction about main axis of rotation 11 outside angular compensation regions 14a and 14b. In particular, mounting elements 17 are arranged in a smaller angular segment about the axial compensation direction, namely in an angular segment of +/−30 degrees about the axial compensation direction.

External gear 2 has a continuous recessed region 19 in inner region 4. Continuous recessed region 19 comprises not only a central hole cutout 20 for a form-fitting accommodation of a collar 21 of differential cage 5, but also two adjacent regions 22a and 22b, which extend in the radial direction relative to main axis of rotation II. Adjacent regions 22a and 22b extend in the pitch circle diameter of ring section 8 before the beginning of flange regions 16a and 16b over the entire angular segment of angular compensation regions 14a and 14b. In the next phase of the radial course adjacent regions 22a and 22b in the pitch circle diameter of mounting elements 17 extend over an angular segment of +/−35 degrees about axes of rotation 12a and 12b. In the next phase of the radial course adjacent regions 22a and 22b extend further than the outer diameter, which is defined by mounting elements 17 or flange regions 16a and 16b. The net result is that recess 19 makes it possible to remove a significant amount of material from external gear 2 and, associated with this material removal, reduce the weight and, notably, the inertia of bevel gear differential 1.

Moreover, flange regions 16a and 16b are also implemented only in sections in the circumferential direction, so that material is also removed from differential cage 5. In particular, flange regions 16a and 16b are arranged outside angular compensation regions 14a and 14b and/or inside angular window regions 15a and 15b.

### LIST OF REFERENCE NUMERALS

1 bevel gear differential
2 external gear
3 external ring
4 internal region
5 differential cage
6a, 6b web regions
7a, 7b window regions
8 ring section
9a, 9b output gears
10a, 10b compensating gears
11 main axis of rotation
12a, 12b axes of rotation
13a, 13b center line of the window regions
14a, 14b angular compensation regions
15a, 15b angular window regions
16a, 16b flange regions
17 mounting elements
18a, 18b connecting regions
19 recessed region
20 hole cutout
21 collar
22a, 22b adjacent regions

1-10. (canceled)

11. A bevel gear differential comprising:
an external gear;
a differential cage rigidly connected to the external gear by means of at least one connecting region;
at least one web region of the differential cage on which a compensating gear is disposed;
an axis of rotation of the compensating gear;
an axial compensation direction defined by the axis of rotation of the compensating gear; and,
at least one angular compensation region of at least +/−20 degrees about the axial compensation direction and arranged in a plane perpendicular to the axial compensation direction, wherein the at least one angular compensation region is freed from the at least one connecting region.

12. The bevel gear differential of claim 11, wherein the differential cage comprises at least one window region with a center line of the at least one window region arranged in the plane perpendicular to the axial compensation direction and further defining a window direction and, about the window direction, at least one angular window region of at least +/−20 degrees, such that the at least one connecting region is arranged in the at least one angular window region.

13. The bevel gear differential of claim 12, wherein the differential cage comprises a circumferential ring section that is closed about a main axis of rotation of the external gear.

14. The bevel gear differential of claim 13, wherein the circumferential ring section comprises at least one flange region and at least one mounting element, such that the at least one flange region is arranged in a circumferential direction relative to the axial compensation direction in the at least one angular window region and arranged to rest on the external gear and is connected to the external gear by means of the at least one mounting element, such that the at least one connecting region is formed.

15. The bevel gear differential of claim 14, wherein the external gear has at least one recessed region arranged to overlap with the at least one angular compensation region and further arranged on a pitch circle shared with the at least one connecting region or the at least one mounting element.

16. The bevel gear differential of claim 15, wherein the at least one recessed region extends in the circumferential direction relative to the axial compensation direction over the entirety of the at least one angular compensation region.

17. The bevel gear differential of claim 16, wherein the at least one recessed region. extends in a radial direction relative to the axial compensation direction further than the at least one connecting region or the at least one flange region.

18. The bevel gear differential of claim 12, wherein the differential cage comprises:
two web regions; and,
two window regions, wherein each of the at least one angular compensation region extends by at least +/−20 degrees about the axial compensation direction and each of the at least one angular window region extends by at least +/−20 degrees about the center line of the at least one window region.

19. The bevel gear differential of claim 18, wherein the external gear comprises:
a central recess, into which the differential cage is inserted; and,
two side recesses, which are arranged so as to overlap with the at least one angular window region and connected to the central recess so as to form the at least one recessed region.

20. The bevel gear differential of claim 19, wherein the external gear has a circumferential toothed ring and an inner region, such that at least 60% of the area of the inner region is formed as the at least one recessed region.
